(19) United States
(12) Patent Application Publication
(10) Pub. No.: US 2019/0379570 A1
(43) Pub. Date: Dec. 12, 2019

(54) BASE STATION APPARATUS, TERMINAL APPARATUS, AND COMMUNICATION METHOD

(71) Applicants: SHARP KABUSHIKI KAISHA, Sakai City, Osaka (JP); FG Innovation Company Limited, Tuen Mun (HK)

(72) Inventors: RYOTA YAMADA, Sakai City (JP); HIROMICHI TOMEBA, Sakai City (JP)

(21) Appl. No.: 16/335,657

(22) PCT Filed: Aug. 29, 2017
(86) PCT No.: PCT/JP2017/030872

§ 371 Date: Aug. 28, 2019

(30) Foreign Application Priority Data
Sep. 29, 2016 (JP) 2016-191051

(51) Int. Cl. H04L 27/26; H04W 72/04; H04W 74/00; H04L 5/00

(52) U.S. Cl. CPC H04L 27/2666; H04W 72/042; H04L 5/001; H04L 27/2607; H04W 74/006

(57) ABSTRACT

To provide a base station apparatus, a terminal apparatus, and a communication method that enable an improvement in communication performance in a system where multiple frame formats are used. Provided is an apparatus including: a higher layer processing unit configured to configure, for a terminal apparatus, a radio parameter including information relating to a plurality of subcarrier spacings and a CP length for each of the plurality of subcarrier spacings; a multiplexing unit configured to map a downlink shared channel to a resource element; and a radio transmitting unit configured to generate, based on the radio parameter, an OFDM signal from an output from the multiplexing unit, convert the OFDM signal into a radio signal, and transmit the radio signal. One of types of CP length is configured for a part of the plurality of subcarrier spacings, and one type of CP length is configured for a remaining part of the plurality of subcarrier spacings.

### TECHNICAL FIELD

The present invention relates to a base station apparatus, a terminal apparatus, and a communication method.

### BACKGROUND ART

In a communication system such as Long Term Evolution (LTE) or LTE-Advanced (LTE-A) standardized by the Third Generation Partnership Project (3GPP), the communication area can be widened by forming a cellular configuration in which multiple areas, covered by base station apparatuses (base stations, transmission stations, transmission points, downlink transmission devices, uplink reception devices, a group of transmit antennas, a group of transmit antenna ports, component carriers, eNodeB, Access Point, and AP) or transmission stations equivalent to the base station apparatuses, are deployed in the form of multiple cells (Cells) being linked together. A terminal apparatus (reception station, reception point, downlink reception apparatus, uplink transmission apparatus, receive antenna group, receive antenna port group, UE, station, and STA) is connected to the base station. In such a cellular configuration, frequency efficiency can be improved by using the same frequency among neighboring cells or sectors.

Research and development activities related to the 5th generation mobile radio communication system (5G system) have been actively carried out, aiming to start commercial services around the year 2020. A vision recommendation on the standard system of the 5G system (International mobile telecommunication—2020 and beyond: IMT-2020) was recently reported (see NPL 1) by the International Telecommunication Union Radio communications Sector (ITU-R), which is an international standardization body.

The 5G system assumes that a radio access network is operated by combining various frequency bands to satisfy various requirements represented by three large use scenarios (Enhanced mobile broadband (EMBB), Enhanced Massive machine type communication (eMTC), and Ultra-reliable and low latency communication (URLLC)). Hence, the 5G system assumes, different from the LTE/LTE-A of the related art, to use multiplexed frame formats having different radio parameters (such as subcarrier spacings) while using the same access scheme.

### CITATION LIST

### Non Patent Literature

NPL 1: “IMT Vision—Framework and overall objectives of the future development of IMT for 2020 and beyond,” Recommendation ITU-R M. 2083-0, September 2015.

### SUMMARY OF INVENTION

### Technical Problem

However, it is assumed that each of multiple frame formats has a suitable communication scheme and a suitable communication method. The 5G system needs to be a system that integrates communications suitable for respective frame formats while maintaining the communications.

The present invention has been made in view of these circumstances, and an object of the present invention is to provide a base station apparatus, a terminal apparatus, and a communication method that enable an improvement in communication performance, such as throughput and communication efficiency, in a system where multiple frame formats are used.

### Solution to Problem

To address the above-mentioned drawbacks, a base station apparatus, a terminal apparatus, and a communication method according to the present invention are configured as follows.

A base station apparatus according to an aspect of the present invention is a base station apparatus for communicating with a terminal apparatus, the base station apparatus including: a higher layer processing unit configured to configure, for the terminal apparatus, a radio parameter including information relating to a plurality of subcarrier spacings and a CP length for each of the plurality of subcarrier spacings; a multiplexing unit configured to map a downlink shared channel to a resource element; and a radio transmitting unit configured to generate, based on the radio parameter, an OFDM signal from an output from the multiplexing unit, convert the OFDM signal into a radio signal, and transmit the radio signal, wherein one of types of CP length is configured for a part of the plurality of subcarrier spacings, and one type of CP length is configured for a remaining part of the plurality of subcarrier spacings.

In the base station apparatus according the aspect of the present invention, the CP length configurable is different depending on carrier frequency range.

In the base station apparatus according the aspect of the present invention, the subcarrier spacing configurable is different depending on carrier frequency range.

A terminal apparatus according to an aspect of the present invention is a terminal apparatus for communicating with a base station apparatus, the terminal apparatus including: a higher layer processing unit configured to cause a radio parameter to be configured by the base station apparatus, the radio parameter including information relating to a plurality of subcarrier spacings and a CP length for each of the plurality of subcarrier spacings; a radio receiving unit configured to extract a signal in a frequency domain from a receive signal, based on the radio parameter; a demultiplexing unit configured to demultiplex a downlink shared channel from the signal extracted in the frequency domain; and a signal detection unit configured to detect a signal of the downlink shared channel, wherein one of types of CP length is configured for a part of the plurality of subcarrier spacings, and one type of CP length is configured for a remaining part of the plurality of subcarrier spacings.

In the terminal apparatus according the aspect of the present invention, the CP length configurable is different depending on carrier frequency range.

In the terminal apparatus according the aspect of the present invention, the subcarrier spacing configurable is different depending on carrier frequency range.

A communication method according to an aspect of the present invention is a communication method in a base station apparatus for communicating with a terminal apparatus, the communication method including: a higher layer processing step of configuring, for the terminal apparatus, a radio parameter including information relating to a plurality of subcarrier spacings and a CP length for each of the plurality of subcarrier spacings; a multiplexing step of mapping a downlink shared channel to a resource element; and a radio transmitting step of generating, based on the radio parameter, an OFDM signal from an output from the multiplexing unit, converting the OFDM signal into a radio signal, and transmitting the radio signal, wherein one of types of CP length is configured for a part of the plurality of subcarrier spacings, and one type of CP length is configured for a remaining part of the plurality of subcarrier spacings.

A communication method in a terminal apparatus for communicating with a base station apparatus, the communication method including: a higher layer processing step of causing a radio parameter to be configured by the base station apparatus, the radio parameter including information relating to a plurality of subcarrier spacings and a CP length for each of the plurality of subcarrier spacings; a radio receiving step of extracting a signal in a frequency domain from a receive signal, based on the radio parameter; a demultiplexing step of demultiplexing a downlink shared channel from the signal extracted in the frequency domain; and a signal detection step of detecting a signal of the downlink shared channel, wherein one of types of CP length is configured for a part of the plurality of subcarrier spacings, and one type of CP length is configured for a remaining part of the subcarrier spacings.

### Advantageous Effects of Invention

According to the present invention, it is possible to improve communication performance in a system where multiple frame formats are used.

### BRIEF DESCRIPTION OF DRAWINGS

FIG. 1 is a diagram illustrating an example of a communication system according to a present embodiment.

FIG. 2 is a diagram illustrating an example of a frame structure according to the present embodiment.

FIG. 3 is a diagram illustrating an example of the frame structure according to the present embodiment.

FIG. 4 is a diagram illustrating an example of the frame structure according to the present embodiment.

FIG. 5 is a diagram illustrating an example of the frame structure according to the present embodiment.

FIG. 6 is a diagram illustrating an example of the frame structure according to the present embodiment.

FIG. 7 is a block diagram illustrating a configuration example of a base station apparatus according to the present embodiment,

FIG. 8 is a block diagram illustrating a configuration example of a terminal apparatus according to the present embodiment.

### DESCRIPTION OF EMBODIMENTS

A communication system according to the present embodiment includes a base station apparatus (a transmitter, a cell, a transmission point, a group of transmit antennas, a group of transmit antenna ports, a component carrier, eNodeB) and terminal apparatuses (a terminal, a mobile terminal, a reception point, a reception terminal, a receiver, a group of receive antennas, a group of receive antenna ports, UE). The base station apparatus connecting to (established a radio link with) the terminal apparatus is referred to as a serving cell.

The base station apparatus and the terminal apparatus in the present embodiment may perform communication in a frequency band for which a license is needed (licensed band) and/or a frequency band for which no license is needed (unlicensed band).

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

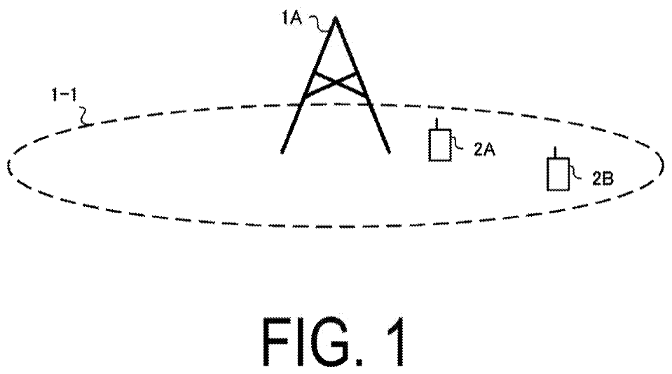

FIG. 1 is a diagram illustrating an example of a communication system according to the present embodiment. As illustrated in FIG. 1, the communication system according to the present embodiment includes a base station apparatus 1A and terminal apparatuses 2A and 2B. Coverage 1-1 is a range (a communication area) in which the base station apparatus 1A can connect to the terminal apparatuses. The terminal apparatuses 2A and 2B are also collectively referred to as terminal apparatuses 2.

With respect to FIG. 1, the following uplink physical channels are used for uplink radio communication from the terminal apparatus 2A to the base station apparatus 1A. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is used to transmit Uplink Control Information (UCI). The Uplink Control Information includes a positive acknowledgement (ACK) or a negative acknowledgement (NACK) (ACK/NACK) for downlink data (a downlink transport block or a Downlink-Shared Channel (DL-SCH)). ACK/NACK for the downlink data is also referred to as HARQ-ACK or HARQ feedback.

Here, the Uplink Control Information includes Channel State Information (CSI) for the downlink. The Uplink Control Information includes a Scheduling Request (SR) used to request an Uplink-Shared Channel (UL-SCH) resource. The Channel State Information refers to a Rank Indicator (RI) specifying a suited number for spatial multiplexing, a Precoding Matrix Indicator (PMI) specifying a suited precoder, a Channel Quality Indicator (CQI) specifying a suited transmission rate, a Reference Signal (CSI-RS) specifying a suited CSI-RS resource, a CSI-RS Resource Indication (CRI), and the like.

The Channel Quality indicator (CQI) (hereinafter, referred to as a CQI value) can be a suited modulation scheme (e.g., QPSK, 16QAM, 64QAM, 256QAM, or the like) and a suited coding rate in a prescribed band (details of which will be described later). The CQI value can be an index (CQI Index) determined by the above change scheme, coding rate, and the like. The CQI value can take a value determined beforehand in the system.

The Rank Indicator and the Precoding Quality Indicator can take the values determined beforehand in the system. Each of the Rank Indicator, the Precoding Matrix Indicator, and the like can be an index determined by the number of spatial multiplexing, Preceding Matrix information, or the like. Note that values of the Rank Indicator, the Precoding Matrix indicator, and the Channel Quality indicator are collectively referred to as CSI values.

The PUSCH is used for transmission of uplink data (an uplink transport block, UL-SCH). Furthermore, PUSCH may be used for transmission of ACK/NACK and/or Channel State Information along with the uplink data. In addition, PUSCH may be used to transmit the Uplink Control Information only.

The PUSCH is used to transmit an RRC message. The RRC message is a signal/information that is processed in a Radio Resource Control (RRC) layer. Further, the PUSCH is used to transmit an MAC Control Element (CE). Here, MAC CE is a signal/information that is processed (transmitted) in a Medium Access Control (MAC)

For example, a power headroom may be included in MAC CE and may be reported via PUSCH. In other words, a MAC CE field may be used to indicate a level of the power headroom.

The PRACH is used to transmit a random access preamble.

In the uplink radio communication, an Uplink Reference Signal (UL RS) is used as an uplink physical signal. The uplink physical signal is not used for transmission of information output from higher layers, but is used by the physical layer. The Uplink Reference Signal includes a Demodulation Reference Signal (DMRS) and a Sounding Reference Signal (SRS).

The DMRS is associated with transmission of the PUSCH or the PUCCH. For example, the base station apparatus 1A uses MARS in order to perform channel compensation of PUSCH or PUCCH. The SRS is not associated with the transmission of the PUSCH or the PUCCH. For example, the base station apparatus 1A uses SRS to measure an uplink channel state.

In FIG. 1, the following downlink physical channels are used for the downlink radio communication from the base station apparatus 1A to the terminal apparatus 2A. The downlink physical channels are used for transmitting information output from the higher layer.
Physical Broadcast Channel (PBCH)
Physical Control Format Indicator Channel (PCFICH)
Physical. Hybrid automatic repeat request Indicator Channel (PHICH)
Physical Downlink Control Channel (PDCCH)
Enhanced Physical Downlink Control Channel (EPDCCH)
Physical Downlink Shared Channel (PDSCH)

The PBCH is used for broadcasting a Master Information Block (MIB, a Broadcast Channel (BCH)) that is shared by the terminal apparatuses. The PCFICH is used for transmission of information indicating a region (e.g., the number of Orthogonal Frequency Division Multiplexing (OFDM) symbols) to be used for transmission of the PDCCH.

The PHICH is used for transmission of ACK/NACK with respect to uplink data (a transport block, a codeword) received by the base station apparatus 1A. In other words, PHICH is used for transmission of a HARQ indicator (HARQ feedback) indicating ACK/NACK with respect to the uplink data. Note that ACK/NACK is also called HARQ-ACK. The terminal apparatus 2A reports ACK/NACK having been received to a higher layer. The ACK/NACK refers to ACK indicating a successful reception, NACK indicating an unsuccessful reception, and DTX indicating that no corresponding data is present. In a case that PHICH for uplink data is not present, the terminal apparatus 2A reports ACK to a higher layer.

The PDCCH and the EPDCCH are used to transmit Downlink Control Information (DCI). Here, multiple DCI formats are defined for transmission of the downlink control information. In other words, a field for the downlink control information is defined in a DCI format and is mapped to information bits.

For example, as a DCI format for the downlink, DCI format 1A to be used for the scheduling of one PDSCH in one cell (transmission of a single downlink transport block) is defined.

For example, the DCI format for the downlink includes downlink control information such as information of PDSCH resource allocation, information of a Modulation and Coding Scheme (MCS) for PDSCH, a TPC command for PUCCH, and the like. Here, the DCI format for the downlink is also referred to as downlink grant (or downlink assignment).

Furthermore, for example, as a DCI format for the uplink, DCI format 0 to be used for the scheduling of one PUSCH in one cell (transmission of a single uplink transport block) is defined.

For example, the DCI format for the uplink includes uplink control information such as information of PUSCH resource allocation, information of MCS for PUSCH, a TPC command for PUSCH, and the like. The DCI format for the uplink is also referred to as uplink grant (or uplink assignment).

The DCI format for the uplink may be used to request Channel State Information (CSI, also referred to as reception quality information) for the downlink (CSI request).

The DCI format for the uplink can be used for a configuration indicating an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (Periodic CSI). The CSI feedback report can be used for a mode configuration (CSI report mode) to periodically report the Channel State Information.

For example, the CSI feedback report can be used for a configuration indicating an uplink resource to report aperiodic Channel State Information (Aperiodic CSI). The CSI feedback report can be used for a mode configuration (CSI report mode) to aperiodically report the Channel State Information. The base station apparatus can configure any one of the periodic CSI feedback report and the aperiodic CSI feedback report. In addition, the base station apparatus can configure both the periodic CSI feedback report and the aperiodic CSI feedback report.

The DCI format for the uplink can be used for a configuration indicating a type of the CSI feedback report that is fed back to the base station apparatus by the terminal apparatus. The type of the CSI feedback report includes wideband CSI (e.g., Wideband CQI), narrowband CSI (e g., Subband CQI), and the like.

In a case that a PDSCH resource is scheduled in accordance with the downlink assignment, the terminal apparatus receives downlink data on the scheduled PDSCH. In a case that a PUSCH resource is scheduled in accordance with the uplink grant, the terminal apparatus transmits uplink data and/or uplink control information of the scheduled PUSCH.

The PDSCH is used for transmission of downlink data (a downlink transport block, DL-SCH). The PDSCH is used to transmit a system information block type 1 message. The system information block type 1 message is cell-specific information.

The PDSCH is used to transmit a system information message. The system information message includes a system information block X other than the system information block type 1. The system information message is cell-specific information.

The PDSCH is used to transmit an RRC message. Here, the RRC message transmitted from the base station apparatus may be shared by multiple terminal apparatuses in a cell. Further, the RRC message transmitted from the base station apparatus 1A may be a dedicated message to a given terminal apparatus 2 (also referred to as dedicated signaling). In other words, user-equipment-specific information (unique to user equipment) is transmitted using a message dedicated to the given terminal apparatus. The PDSCH is used for transmission of MAC CE.

Here, the C message and/or MAC CE is also referred to as higher layer signaling.

The PDSCH can be used to request downlink channel state information. The PDSCH can be used for transmission of an uplink resource to which a CSI feedback report is mapped, the CSI feedback report being fed back to the base station apparatus by the terminal apparatus. For example, the CSI feedback report can be used for a configuration indicating an uplink resource for periodically reporting Channel State Information (Periodic CSI). The CSI feedback report can be used for a mode configuration (CSI report mode) to periodically report the Channel State Information.

The type of the downlink CSI feedback report includes wideband CSI (e.g., Wideband CSI) and narrowband CSI (e.g., Subband CSI). The wideband CSI calculates one piece of Channel State Information for the system band of a cell. The narrowband CSI divides the system band in predetermined units, and calculates one piece of Channel State Information for each division.

In the downlink radio communication, a Synchronization signal (SS) and a Downlink Reference Signal (DL RS) are used as downlink physical signals. The downlink physical signals are not used for transmission of information output from the higher layers, but are used by the physical layer.

The synchronization signal is used for the terminal apparatus to take synchronization in the frequency domain and the time domain in the downlink. The Downlink Reference Signal is used for the terminal apparatus to perform channel compensation on a downlink physical channel. For example, the Downlink Reference Signal is used for the terminal apparatus to calculate the downlink Channel State Information.

Here, the Downlink Reference Signals include a Cell-specific Reference Signal (CRS), a UE-specific Reference Signal (URS) or a terminal apparatus-specific reference signal relating to PDSCH, a Demodulation Reference Signal (DMRS) relating to EPDCCH, a Non-Zero Power Channel State Information-Reference Signal (NZP CSI-RS), and a Zero Power Channel State Information-Reference Signal (ZP CSI-RS).

The CRS is transmitted in all bands of a subframe and is used to perform demodulation of PBCH/PDCCH/PHICH/PCFICH/PDSCH. The URS relating to PDSCH is transmitted in a subframe and a band that are used for transmission of PDSCH to which URS relates, and is used to demodulate PDSCH to which URS relates.

The DMRS relating to EPDCCH is transmitted in a subframe and a band that are used for transmission of EPDCCH to which DMRS relates. The DMRS is used to demodulate EPDCCH to which DMRS relates.

A resource for NZP CSI-RS is configured by the base station apparatus 1A. The terminal apparatus 2A, for example, performs signal measurement (channel measurement), using NZP CSI-RS. A resource for ZP CSI-RS is configured by the base station apparatus 1A. With zero output, the base station apparatus 1A transmits ZP CSI-RS. The terminal apparatus 2A performs interference measurement in a resource to which NZP CSI-RS corresponds, for example.

A Multimedia Broadcast multicast service Single Frequency Network (MBSFN) RS is transmitted in all bands of the subframe used for transmitting PMCH. The MBSFN RS is used to demodulate PMCH. The PMCH is transmitted on the antenna port used for transmission of MBSFN RS.

Here, the downlink physical channel and the downlink physical signal are also collectively referred to as a downlink signal. The uplink physical channel and the uplink physical signal are also collectively referred to as an uplink signal. The downlink physical channels and the uplink physical channels are collectively referred to as physical channels. The downlink physical signals and the uplink physical signals are also collectively referred to as physical signals,

The BCH, UL-SCH, and DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like is performed for each codeword.

The base station apparatus cab aggregate multiple Component Carriers (CCs) for broadband transmission with an even broader band, to communicate with a terminal apparatus supporting Carrier Aggregation (CA). In carrier aggregation, one Primary Cell (PCell) and one or multiple Secondary Cells (SCells) are configured as a set of serving cells.

In Dual Connectivity (DC), a Master Cell Group (MCG) and a Secondary Cell Group (SCG) are configured as a group of serving cells. The MCG includes a PCell and optionally includes one or multiple SCells. The SCG includes a primary SCell (PSCell) and optionally includes one or multiple SCells.

The base station apparatus can perform communication by using radio frames. Each of the radio frames is constituted of multiple subframes (subframe periods). In a case of expressing a frame length in time, a radio frame length may be 10 milliseconds (ms), and a subframe length may be 1 ms, for example. In this example, each radio frame is constituted of 10 subframes. Each subframe includes multiple OFDM symbols, and hence, the subframe length may be expressed in the number of OFDM symbols. For example, each subframe may correspond to the number of OFDM symbols in a reference subcarrier spacing. For example, the number of OFDM symbols indicating a subframe length may be 14 OFDM symbols. Moreover, each subframe is constituted of multiple slots. Each slot is expressed in the number of OFDM symbols in a subcarrier spacing to he used for transmission. The number of OFDM symbols in each slot may relate to the number of OFDM symbols in the subframe. For example, the number of OFDM symbols in the slot may be the same as or half the number of OFDM symbols in the subframe. In the following description, a subframe length is assumed to be 1 ms in a case of representing the subframe length in time. However, the present invention is not limited to this. Each subframe/slot may include an uplink period for communication of an uplink signal/channel and/or a downlink period for communication of a downlink signal/channel. In other words, each subframe/slot may be constituted only of an uplink period, may be constituted only of a downlink period, or may be constituted of an uplink period and a downlink period. The subframe/slot may include a guard period (null period). Note that the position at which a guard period may be mapped and/or the length of a guard period, may be fixed or may be configured by the base station apparatus. The length of the guard period possible to be configured may be different depending on whether the guard period is mapped in an early period or a later period in the subframe/slot. In a subframe/slot including an uplink period, the downlink period, and the guard period, the lengths of the respective periods may be fixed depending on the mapping of the periods. The base station apparatus may configure, in higher layers, the mapping and the lengths of the uplink period/downlink period/guard period in each subframe/slot, and may transmit the configured mapping and lengths of the periods to a terminal in control information. The base station apparatus may make such a configuration for each subframe/slot or subframe group. In addition, a mini-slot, which is shorter than a slot, may be defined. A subframe/slot/mini-slot may serve as a unit of scheduling.

Each subframe/slot includes one or multiple OFDM symbols. In the following embodiment, each OFDM symbol refers to one generated based on Inverse Fast Fourier Transform (IFFT), and each OFDM signal refers to one obtained by adding a guard period to an OFDM symbol. Note that a guard period here refers to a zero period (null period), a Cyclic Prefix (CP), or the like.

Multiple parameters may be configured for generating OFDM symbols. The parameters include a subcarrier spacing and/or the number of Fast Fourier Transform (FFT) points. A base parameter, which is a parameter serving as a basis of the multiple parameters, is configured. The base parameter is also referred to as a reference parameter. The parameters other than the base parameter may be obtained based on the base parameter. For example, in a case that the subcarrier spacing of the base parameter is 15 kHz, each of the parameters other than the base parameter may be that obtained by multiplying 15 kHz by N. Note that N is an integer, m-th power of 2, or a fraction. Note that m is an integer and includes a negative number, e.g., m=−2. Note that this N or m is also referred to as a scale factor of a subcarrier spacing (parameter set). Parameters with a fixed value, such as a subcarrier spacing, are also referred to as a parameter set. In the following embodiment, a description will be given, as an example, that a subcarrier spacing is 15 kHz in a first parameter set and a subcarrier spacing is 30 kHz in a second parameter set. However, the present invention is not limited to this. In addition, the number of parameter sets the base station apparatus may configure is not limited to two. In the following embodiment, the number of FFT points is assumed to be the same for the first parameter set and the second parameter set, unless otherwise noted. This means that, in a case of a greater subcarrier spacing, the OFDM symbol length is shorter. An OFDM symbol generated using the first parameter set is also referred to as a first OFDM symbol, and an OFDM symbol generated using the second parameter set is also referred to as a second OFDM symbol.

To reduce an influence of phase noise and the like, a subcarrier spacing is preferably increased for higher carrier frequencies (band). In this way, the base station apparatus may configure a base parameter set in the carrier frequencies (band) or a carrier frequency range (band range). For example, it is assumed that carrier frequencies lower than 6 GHz correspond to a first carrier frequency range (band range), carrier frequencies equal to or higher than 6 GHz and lower than 40 GHz correspond to a second carrier frequency range (band range), and carrier frequencies equal to or higher than 40 GHz correspond to a third carrier frequency (band range). In this case, the base station apparatus may configure the subcarrier spacing at 15 kHz as the base parameter in the first carrier frequency range. The base station apparatus may configure the subcarrier spacing at 30 kHz as the base parameter in the second carrier frequency range. In this case, the base station apparatus may configure the subcarrier spacing at 60 kHz in the third carrier frequency range the base parameter.

Multiple kinds of CP length may be configured, Multiple kinds of CP length may be configured for each parameter set. Here, a description will be given of a case where two kinds of CP length are configured. The two kinds of CP are referred to also as a first CP and a second CP. For the same parameter set, the second CP length is longer than the first CP length. The ratio of each of the first CP length and the second CP length to the OFDM symbol (overhead) may be configured to be in the same level for all the parameter sets. Note that the first CP may be referred to as a normal CP, and the second CP may be referred to as an extended CP. An OFDM signal in which a first CP is added to a first OFDM symbol is also referred to as a first OFDM signal −1, and an OFDM signal in which a second CP is added to a first OFDM symbol is also referred to as a first OFDM signal −2. An OFDM signal in which a first CP is added to a second OFDM symbol is also referred to as a second OFDM signal −1, and an OFDM signal in which a second CP is added to a second OFDM symbol is also referred to as a second OFDM signal −2. Note that there may be a parameter set for which multiple CP lengths are not configured. Moreover, a different number of CP lengths may be configured for each parameter set. There may be a special parameter set for which multiple CP lengths may be configured. Note that, in the above and the following embodiment, a description may be given of a case of an OFDM symbol/signal even in the uplink (case where a terminal apparatus performs transmission). However, an OFDM symbol/signal here includes an OFDM symbol/signal and an SC-FDMA symbol/signal unless otherwise noted. A different parameter set and a different CP length may be configured for the downlink and the uplink. The terminal apparatus may demodulate a downlink signal (OFDM signal) by using a parameter set and a CP length configured for the downlink and transmit an uplink signal (OFDM signal or SC-FDMA signal) by using a parameter set and a CP length configured for the uplink. Note that the reference parameter may be common to the uplink and the downlink. In this case, the subframe lengths obtained by using the reference parameter are the same between the uplink and the downlink.

Note that the number of subframes/the number of slots included in a prescribed time period may be different between the uplink and the downlink. For example, the number of subframes/the number of slots included in the prescribed time period in the downlink may be configured to be smaller than the number of subframes/the number of slots included in the prescribed time period in the uplink, and vice versa. A base station apparatus and a terminal apparatus in such a communication system may provide a communication service in which different requirements are configured between the uplink and the downlink. The communication service is, for example, a communication service in which high-speed transmission, such as video transmission, is performed in the downlink while a response to the video transmission with low delay is necessary in the uplink. Hence, the communication service includes a case where the subframe length for the uplink needs to be configured shorter than the subframe length for the downlink. Again, a case where the subframe length for the downlink needs to be configured shorter than the subframe length for the uplink is also included in the present embodiment.

In a case that, by using a part of the uplink or downlink resources, transmission in another link (e.g., a sidelink) is performed, the terminal apparatus may perform transmission in the sidelink by using a parameter set and a CP length different from the parameter set and the CP length configured in the case of performing uplink transmission (or downlink transmission) by using the part of resources, or a parameter set and a CP length may be configured by the base station apparatus. As a matter of course, the terminal apparatus may perform transmission in the sidelink by using the same parameter set and CP length as the parameter set and the CP length configured in the case of performing uplink transmission (or downlink transmission) by using the part of resources. A dedicated parameter set and CP length for a sidelink may be configured for the terminal apparatus.

In the present embodiment, the size of each time domain, such as a frame length, a symbol length, or a CP length, is expressed in basic unit of time Ts. Note that, unless otherwise noted, points indicate the number of certain Ts. For example, in a case of expressing a CP by using NCP points, the CP length corresponds to the product of NCP and Ts. Here, the basic, unit of time Ts may be obtained based on the subcarrier spacing and the FFT size (the number of FFT points). Here, assume that the subcarrier spacing is denoted by SCS and the number of FFT points is denoted by NFFT. In this case, Ts=1/(SCS*NFFT) seconds (here, / denotes division). Based on this, in a case that the number of FFT points remains unchanged, the subcarrier spacing multiplied by N causes the CP length to be divided by N. Note that Ts may, for example, be a time unit based on a reference parameter (subcarrier spacing and/or the number of FFT points), such as SCS=15 kHz and/or NFFT=2048 points. In this case, the basic unit of time in a case that the subcarrier spacing is 15N kHz is Ts/N (here, / denotes division). Even in a case that SCSs remains unchanged, NFFT multiplied by N causes the basic unit of time to be Ts/N (here, / denotes division).

In a case that NFFT is in common, the number of CP points may be common to all the parameters. For example, the first CP may be 160/144 points, and the second CP may he 512 points. In a case that NFFTs are equal to each other, system bandwidths are different depending on the SCSs. Note that such a system bandwidth determined based on a SCS is also referred to as a reference system bandwidth. For example, the reference system bandwidth in a case of SCS=15 kHz may be 20 MHz, and the reference system bandwidth in a case of SCS=60 kHz may be 80 MHz. In a case that system bandwidths are equal to each other among SCSs, a different NFFT is configured for each SCS, Tss are made equal to each other based on the SCSs, and the numbers of CP points are made different according to the SCSs. Note that not all the parameter sets need to follow a unified rule according to change of SCS, e.g., N times. In other words, the overheads of the first CP/the second CP may not necessarily be equal to each other among all the parameter sets. For example, in a case that N is a fraction, the overhead of a CP may be reduced. In a case that N is four or greater and the reference system bandwidth is large, the overhead of a CP may be reduced. Note that a CP having a shorter overhead than that of the first CP is also referred to as a Shortened CP (SCP). A shortened CP is also referred to as a third CP. Note that the third CP may include a case of NCP=0. A signal in which the third CP is added to an OFDM symbol is also referred to as an OFDM signal −3. Note that the OFDM signal −3 may be configured not to be time-multiplexed to the OFDM signal −1 or the OFDM signal −2. The OFDM signal −3 may be configured not to he time/frequency-multiplexed to the OFDM signal −1 or the OFDM signal −2. The base station apparatus may also configure a terminal apparatus specific CP length (guard period length, zero period length, or null period length) in a case that the third CP is added. In this case, the base station apparatus may transmit the third CP on a control channel common in the cell and transmit the terminal-specific CP length on a terminal-specific control channel.

In general, in a case of carrier frequencies in the same level, delay spreads are similar irrespective of subcarrier spacings. For this reason, CP lengths with little influence of delay spread are preferably configured. Hence, the base station apparatus may configure a CP length to serve as a basis (reference) for each parameter set in carrier frequencies or a carrier frequency range. For example, in the first carrier frequency range, the base CP for the first parameter set may be a first CP, and the base CP for the second parameter set may be a second CP. Note that, delay spread is affected by the coverage (transmit power) and the cell radius of the base station apparatus, the distance between the base station apparatus and the terminal apparatus, and the like, and hence a different CP length may be used for each base station apparatus/terminal apparatuses in a case of the same carrier frequencies, to allow efficient communication. In this way, the base station apparatus/terminal apparatus may multiplex an OFDM symbol to which the first CP is added and an OFDM symbol to which the second CP is added in time domain frequency domain and transmit the resultant in the same subframe. The same parameter set or different parameter sets may be used for the OFDM symbol to which the first CP is added and the OFDM symbol to which the second CP is added. In a case that a subframe is assumed to correspond to the number of OFDM symbols in the reference parameter (subcarrier spacing), the number of OFDM symbols may be obtained by taking the first CP into consideration or may be obtained by taking the second CP into consideration. The first CP, the second CP, or the CP length may be included in the reference parameter.

Note that the parameter set supported by the terminal apparatus is reported to the base station apparatus as a function (capability) of the terminal apparatus or a category of the terminal apparatus. Information indicating whether the first CP/second CP/third CP is supported in a certain subcarrier spacing may be included in the function (capability) of the terminal apparatus or the category of the terminal apparatus. Information indicating whether the first CP second CP/third CP is supported may be indicated for each band or for each band combination. The base station apparatus may transmit a transmit signal of the parameter set or the CP length supported by the terminal apparatus according to the function (capability) of the terminal apparatus received from the terminal apparatus or the category of the terminal apparatus.

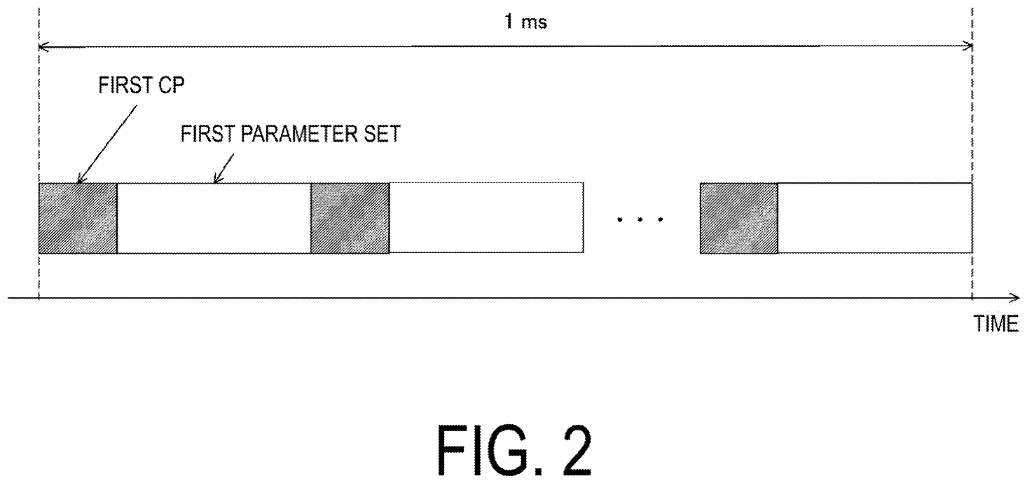

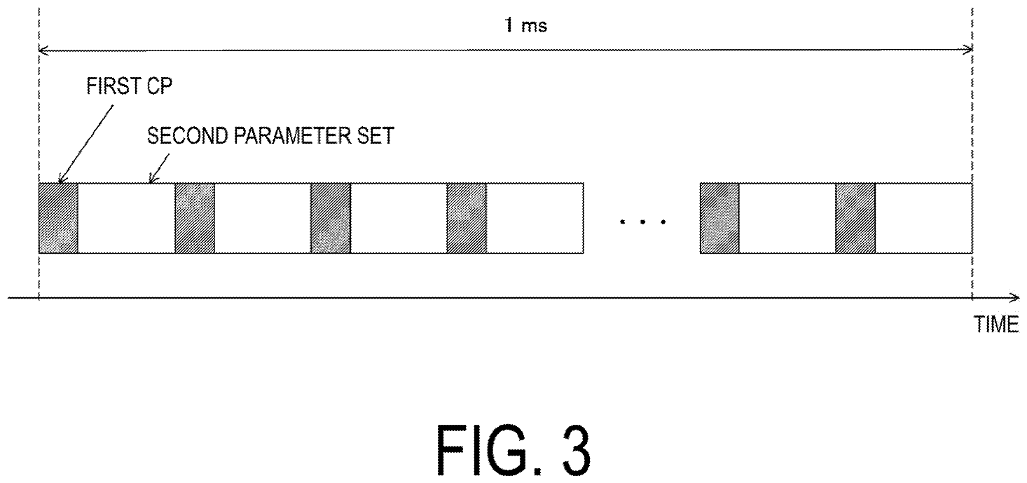

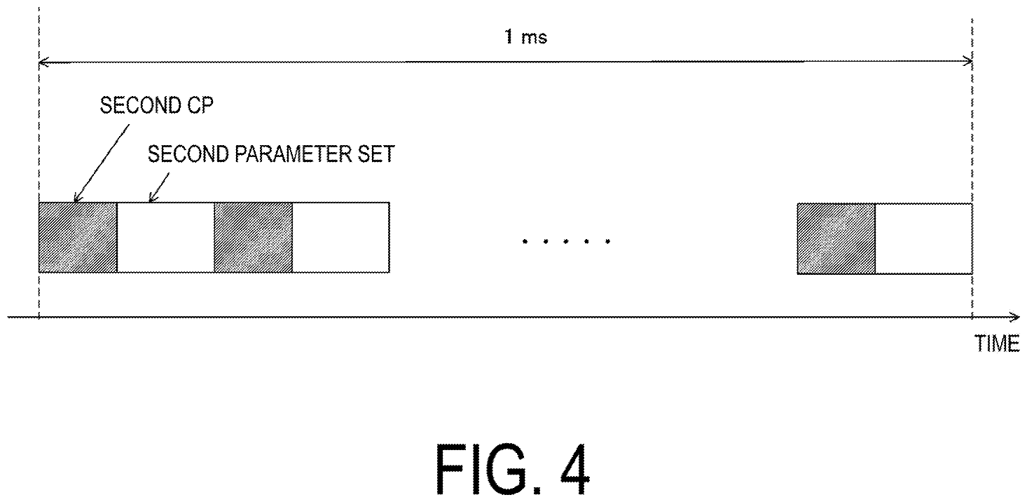

FIG. 2 to FIG. 6 are examples of a subframe structure. FIG. 2 is a diagram illustrating an example of a subframe constituted of a first OFDM signal −1. FIG. 3 is a diagram illustrating an example of a subframe constituted of a second OFDM signal −1. The subcarrier spacing for the first parameter set is 15 kHz and the subcarrier spacing for the second parameter set is 30 kHz, and hence the length of the second OFDM signal −1 is half the length of the first OFDM -1. Hence, in a case of assuming that 14 first OFDM signals −1 are included in 1 ms, 28 second OFDM signals −1 are included in 1 ms. FIG. 4 is a diagram illustrating an example of a subframe constituted of a second OFDM signal −2. Propagation environments, such as multi-path delay, are considered to be similar in the same carrier frequencies (band) irrespective of parameters. Hence, a requested CP length is preferably determined for each carrier frequencies (band). In this case, the base station apparatus transmits an OFDM symbol with a suitable CP length for each carrier frequencies (band). At this event, the terminal apparatus performs reception processing in the CP length determined for the carrier frequencies (band) or the configured CP length.

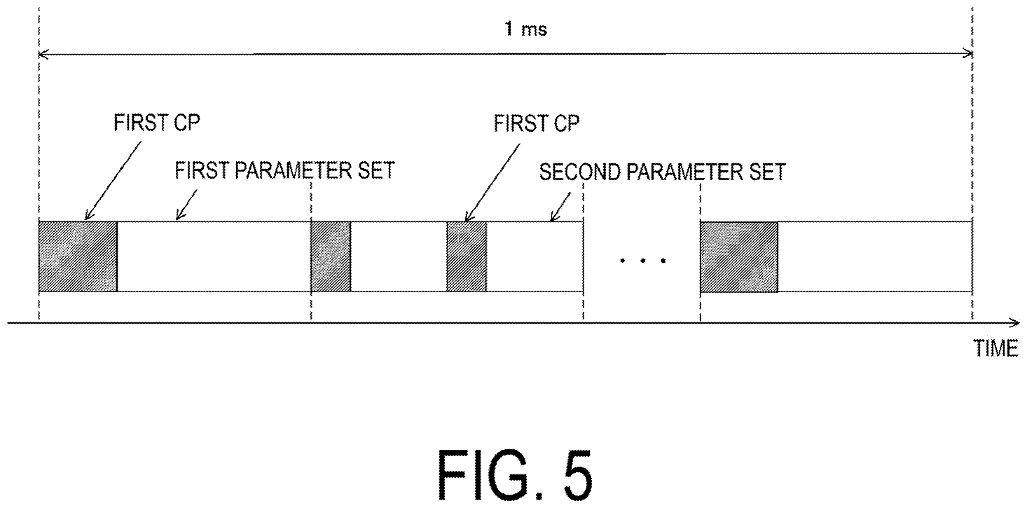

FIG. 5 is an example in which first OFDM signals −1 and second OFDM signals −1 are multiplexed in 1 ms. The length of each second OFDM signal −1 is half the length of each first OFDM −1, and hence the period of the first OFDM signal −1 includes two second OFDM signals −1. For this reason, the base station apparatus may select to map a first OFDM signal −1 or to map two second OFDM signals −1, for each period of the first OFDM signal −1. In the example of FIG. 5, two second OFDM signals −1 are mapped to the second period of the first OFDM signal −1. Note that a CP length may be different in a little for each OFDM signal. For example, in the Long Term Evolution (LTE), the subcarrier spacing is 15 kHz, and 14 first OFDM signals −1 are included in a subframe. Among the 14 first OFDM signal −1, the length of CPs added to the first OFDM signal and the eighth OFDM signal and the length of CPs added to the other OFDM signals are different from each other. In a case of a parameter similar to that in LTE with a subcarrier spacing of 30 kHz, among 28 second OFDM signals −1, the length of CPs added to the first, eighth, 15-th, and 22nd second OFDM signals −1 and the length of CPs added to the other second OFDM signals −1 are different from each other. In this case, periods of the first OFDM signals −1 in each of which two second OFDM signals are included are limited. To address this, in a case of a subcarrier spacing of 30 kHz, among 28 second OFDM signals −1, the length of CPs added to the first, second, 15th, and 16th second OFDM signals −1 and the length of CPs added to the other second OFDM signals −1 are configured to be different from each other. In this way, two second OFDM signals −1 are included in each of the periods of 14 first OFDM signals −1, and this increases flexibility.

The terminal apparatus performs time/frequency synchronization by using a synchronization signal/discovery signal to perform cell search to detect a physical cell identity (PC ID, cell ID, and/or system ID) and/or beam search to detect beam identifier (beam ID and/or beam cell ID). Note that a cell ID may include a beam ID. To differentiate the cell ID including a beam ID from a cell ID not including a beam ID, the cell II) including a beam ID is also referred to as an extended cell ID. A discovery signal includes a part of or all a synchronization signal, a cell-specific reference signal, and a CSI-RS. In a case that a synchronization signal is generated based on the cell ID and the beam ID, the terminal apparatus can acquire the cell ID and the beam ID from a synchronization signal sequence. In a case that the base station apparatus changes a beam pattern, based on a radio resource, such as a subframe to which a synchronization signal is mapped, the synchronization signal is generated based on the cell ID and radio resource information. The radio resource information is, for example, a subframe number or a subband number.

The number of kinds of synchronization signals may be one or may be multiple. In a case that two kinds of synchronization signals, i.e., a Primary Synchronization Signal (PSS) and a Secondary Synchronization Signal (SSS), are used, the cell ID and/or the beam ID may be acquired by using both the PSS and the SSS. Different functions may be assigned to the respective kinds. For example, the cell ID may be identified using the PSS, and the beam ID may be identified using the SSS. In another example, the cell ID may be identified using the PSS and the SSS, and the beam ID may be identified using another kind of synchronization signal.

In a case that the base station apparatus supports data communications using the first parameter set and the second parameter set in the same carrier frequencies (band), the base station apparatus may transmit a synchronization signal/discovery signal by using a first parameter and/or a second parameter. In other words, the base station apparatus may transmit a synchronization signal/discovery signal by using a parameter determined for each carrier frequencies/band. In this case, the terminal apparatus receives a synchronization signal/discovery signal of the parameter determined for each carrier frequencies/band to perform cell search. The base station apparatus may transmit a synchronization signal/discovery signal by using multiple parameters in certain carrier frequencies/band. In this case, the terminal apparatus may receive synchronization signals/discovery signals of the multiple parameters to perform cell search. Alternatively, for example, in a case that parameters are determined for each service, the terminal apparatus may receive synchronization signals/discovery signals of desired parameters to perform cell search.

The base station apparatus may configure a common signaling period in a certain subframe. A common signaling period length may be configured in the number of OFDM symbols or time. In the common signaling period, a part of or all a cell-specific reference signal, a CSI-RS, and a synchronization signal are transmitted. In a case of the same common signaling length, the numbers of symbols included in common signaling periods may be different between different parameter sets. For example, in a case of a common signaling period including two first OFDM signals −1, four second OFDM signals −1 are included in the same common signaling period length. Hence, in a case of transmitting a synchronization signal in the common signaling period, it is possible to transmit a greater number of synchronization signals through the second OFDM signal −1 than that through the first OFDM signal −1, and hence accuracy of synchronization can be improved with a second OFDM signal −1. From a viewpoint of cell search, it is possible to transmit a synchronization signal through the second OFDM signal −1 at a higher repetition rate, and this enables an increase in coverage with accurate synchronization. Note that the common signaling period may be a fixed length.

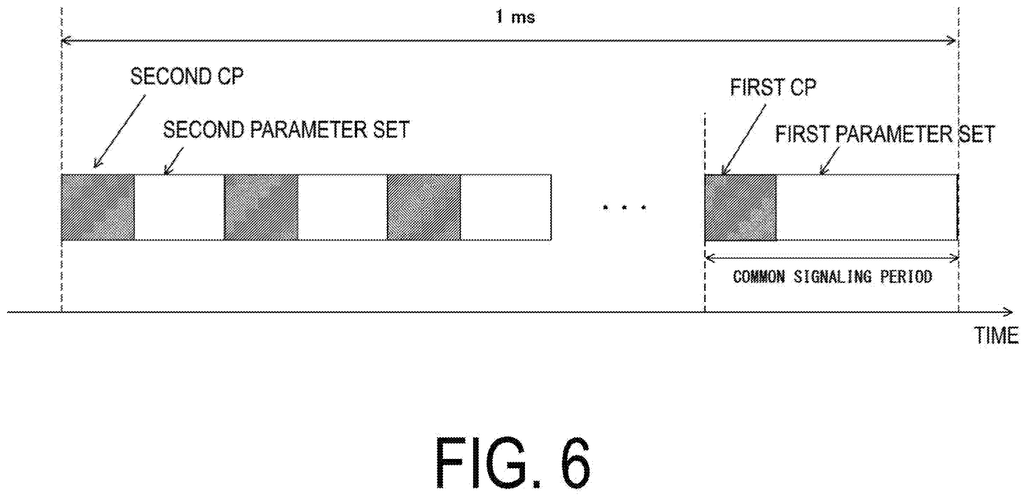

In a case that the base station apparatus transmits a synchronization signal/discovery signal by using a parameter determined based on certain carrier frequencies (e.g., the first parameter set) and a data signal is transmitted by using another parameter (e.g., the second parameter set), the data signal may be transmitted by using the first parameter set, and the synchronization signal discovery signal may be transmitted by using the second parameter set. In this case, the terminal apparatus synchronizes with the base station apparatus, based on a synchronization signal/discovery signals by using the second parameter set and demodulates the data signal by using the first parameter set. FIG. 6 is a diagram illustrating an example of a subframe structure in a case of transmitting a data signal by using the second parameter set and transmitting a synchronization signal by using the first parameter set. In the example in FIG. 6, a common signaling period, which is a signaling period common in the cell (in the subframe), is configured in 1 ms. Signals transmitted in the common signaling period may be of the same signal sequence in a cell or may be of different signal sequences for respective terminal apparatuses. The common signaling period length may be fixed or may be configured by the base station apparatus. Note that different parameters may be used for a primary synchronization signal and a secondary synchronization signal. For example, the base station apparatus may transmit a primary synchronization signal by using a parameter common in a cell (the first parameter set in the example in FIG. 6) and may transmit a secondary synchronization signal by using the same parameter (the second parameter set in the example in FIG. 6) as that for the data signal. Note that a synchronization signal using a parameter common in a cell is also referred to as a cell specific synchronization signal, and a synchronization signal using a UE specific parameter is also referred to as a terminal specific synchronization signal (UE specific synchronization signal). The common signaling period only needs to be configured in a subframe in which a synchronization signal is to be transmitted. For example, in a case that a synchronization signal is transmitted every 5 ms (or five subframes), the common signaling period is also configured every 5 ms (or five subframes) Note that a discovery signal may include a cell-specific synchronization signal. Note that a transmission cycle of a synchronization signal may be configured by the base station apparatus. The transmission cycle of a synchronization signal may be included in system information. Note that a parameter set common in a cell to be used for a synchronization signal and the like may be the same as the reference parameter set or the reference CP. In this case, the base station apparatus no longer needs to transmit a parameter set for a synchronization signal, and this can reduce overhead. The parameter set common in a cell may be different from the reference parameter set or the reference CR In this case, flexibility of the system increases, and hence the base station apparatus/terminal apparatus may configure parameters suitable for various use cases and scenarios.

The base station apparatus may frequency-multiplex multiple parameter sets. For example, in a certain subframe, the base station apparatus uses the first parameter set in a subband and uses the second parameter set in another subband, in a system band. In other words, signals of different subcarrier spacings are multiplexed in the system band. In a case that the power spectral density in the system band is fixed, a signal power per subcarrier of the first parameter set is lower than a signal power per subcarrier of the second parameter set. In other words, in a case that the numbers of subcarriers allocated to the transmit signal based on the first parameter set and the transmit signal based on the second parameter set are the same, a transmit power of the first parameter set is lower than a transmit power of the second parameter set. In this case, the terminal apparatus obtains a receive power of the second parameter set, based on a receive power of the first parameter set, for demodulation. Note that, to match synchronization accuracies of the parameter sets, the transmit power of the first parameter set and the transmit power of the second parameter set for a synchronization signal are preferably in the same level as a synchronization signal. For example, the number of subcarriers for a synchronization signal using the first parameter set is twice the number of subcarriers for a synchronization signal of the second parameter set in the same system band. Alternatively, the number of subcarriers for a synchronization signal of the first parameter set and the number of subcarriers for a synchronization signal of the second parameter set are assumed to be the same, and signal powers per subcarrier are assumed to be the same. In a case that the base station apparatus transmits a reference signal common to the first parameter set and the second parameter set, the terminal apparatus may acquire parameter set specific transmit powers for a data signal/reference signal of different parameter sets, based on the transmit power of the reference signal.

The subframe structure may change depending on whether or not used is an anchor cell, such as a macro cell. For example, the base station apparatus may transmit a subframe for which a common signaling period is configured, in a PCell while not necessarily transmitting a subframe for which a common signaling period is configured, in an SCell. In other words, configurations relating to a common signaling period may be different between a PCell and an SCell, and the base station apparatus may not configure any common signaling period in the SCell. The base station apparatus may change the number of parameter sets for each cell in the same band. For example, the base station apparatus may transmit a signal using a single parameter set in the PCell and transmit a signal using multiple parameter sets in the SCell. The base station apparatus may perform transmission using a common parameter set for each CC. In this case, the terminal apparatus performs communication by using a parameter set configured in the PCell, in the SCell.

The base station apparatus may acquire suitable CSI from CSI report from the terminal apparatus. The CSI reported by the terminal apparatus includes CQI/PMI/RI/CRI/PSI. The Parameter Set Indication (PSI) is an indication indicating a suitable parameter set among multiple parameter set. The CSI is calculated based on a cell specific reference signal and a CSI-RS. Note that the CSI-RS may transmit (configure) a non-precoded CSI-RS, which is not beamformed, and/or a beamformed CSI-RS. The base station apparatus may include information of the non-precoded CSI-RS and information of the beamformed CSI-RS in CSI-RS configuration information. The information of the non-precoded CSI-RS includes a part of or all information of Codebook Subset Restriction (CBSR), information of a codebook, and interference measurement restriction, which is a configuration of whether or not to put resource restriction at the time of measuring interference. The information of the beamformed CSI-RS includes a part of or all an ID list of CSI-RS configurations, an ID list of CSI-Interference Measurement (CSI-IM) configurations, information of codebook subset restriction, and channel measurement restriction, which is a configuration of whether or not to put resource restriction at the time of channel measurement. The ID list of CSI-IM configurations is constituted of ID information of one or multiple CSI-IM configurations, and the ID information of the CSI-IM configurations includes a part of or all CSI-IM configuration IDs and the interference measurement restriction. The CSI-IM is used for interference measurement.

The base station apparatus may include, in higher layer signaling, a configuration (CSI process) relating to a process of calculating channel state information, in association at least with the CSI-RS for channel measurement and the CSI-IM for interference measurement. The CSI process may include a part of or all a CSI process ID, the information of the non-precoded CSI-RS, and the information of the beamformed CSI-RS. The base station apparatus may configure one or more CSI processes. The base station apparatus may generate CSI feedback for each of the CSI processes independently. The base station apparatus may configure a different CSI-RS resource and a different CSI-IM for each CSI process. One or more CSI processes are configured for the terminal apparatus, and the terminal apparatus performs CSI report for each of the configured CSI processes independently. Each CSI process may be configured in a prescribed transmission mode.

For example, inter-carrier interference occurs in high-speed movement, and for this reason, a wider subcarrier spacing is preferable than that for low-speed movement. In this way, the base station apparatus may transmit a CSI-RS configuration for CSI report for each parameter set. For this transmission, the terminal apparatus may calculate a CSI for each parameter set to report the CSI to the base station apparatus. The base station apparatus may include a configuration of the parameter set in a single CSI-RS configuration. In this case, the terminal apparatus selects a suitable parameter set from configured multiple parameter sets to report a PSI. Note that the base station apparatus may map a CSI-RS of a parameter set different from that for data transmission, to a common signaling period. The terminal apparatus may transmit, to the base station apparatus, a scheduling request and a communication request using a parameter set different from that for data transmission. In this case, the base station apparatus transmits a CSI-RS of the different parameter set in response to a request from the terminal apparatus.

As described above, the base station apparatus has a possibility of transmitting a signal using multiple parameter sets in certain carrier frequencies. In a case that a neighbor cell also supports multiple parameter sets, the terminal apparatus has a possibility of receiving a signal of a different parameter set as neighbor cell interference. To reduce neighbor cell interference, the terminal apparatus is able to cancel or suppress the neighbor cell interference. In a case that the terminal apparatus has a function of canceling or suppressing neighbor cell interference, the base station apparatus may transmit assist information (neighbor cell information) for canceling or suppressing neighbor cell interference. The assist information includes a part of or all physical cell ID, the number of CRS ports, a P_{A} list, P_{B}, a Multimedia Broadcast multicast service Single Frequency Network (MBSFN) subframe configuration, a transmission mode list, a resource allocation granularity, a subframe structure, a ZP/NZP CSI-RS structure, quasi co-location (QCL) information, a frame format, a supporting parameter set, a parameter set configured for each subframe, a CP length, FFT size, a system band, and whether used is LTE or not. Note that P_{A} denotes a power ratio (power offset) of PDSCH and CRS in an OFDM symbol to which CRS is not mapped. P_{B} denotes a power ratio (power offset) of PDSCH in an OFDM symbol to which CRS is mapped and PDSCH in an OFDM symbol to which CRS is not mapped. The subframe structure is information indicating whether the subframe is related to uplink, downlink, or uplink and downlink. The QCL information is information relating to QCL for a prescribed antenna port, a prescribed signal, or a prescribed channel. In a case that a long term feature of a channel on which a symbol is transmitted through one of two antenna ports may be estimated from a channel on which a symbol is transmitted through the other antenna port, the antenna ports are referred to as being QCL. The long term feature includes delay spread, Doppler spread, Doppler shift, average gain, and/or average delay. In other words, in a case that two antenna ports are QCL, the terminal apparatus may consider that the long term features of the antenna ports are the same. For each of the parameters included in the above-described assist information, one value (candidate) may be configured, or multiple values (candidates may be configured. In the case of multiple values being configured, the terminal apparatus interprets that a value possible to be configured by the base station apparatus to interfere is indicated for the parameter, and detects (specifies) a parameter configured in an interference signal in the multiple values. The above-described assist information may be used to cancel or suppress a part of or all a reference signal transmitted from the neighbor cell, the PDSCH, and the (E)PDCCH. The above-described assist information may be used to perform various measurements. The measurements include Radio Resource Management (RRM) measurement, Radio Link Monitoring (RLM) measurement, and Channel State Information (CSI) measurement.

In a case of determining that the neighbor cell interference is of the LTE, the terminal apparatus may cancel or suppress the interference signal by using the assist information. In a case that the subframe configuration information transmitted in a serving cell and the subframe configuration information transmitted in neighbor cell interference are the same, the terminal apparatus may cancel/suppress an interference signal by using the assist information. The subframe configuration information being the same means, for example, a case that the serving cell and a subframe of the neighbor cell are of the downlink, a case of the same parameter set, and/or a case of the same CP length, for example. In a case that the subframe configuration information transmitted from the serving cell and the subframe configuration information transmitted from neighbor cell are different, the terminal apparatus suppresses interference in a linear method instead of performing neighbor cell interference cancellation using assist information. This is for example, a case where the neighbor cell transmits an uplink subframe, a case where parameter sets are different, and a case where CP lengths are different. In a case of having a possibility of performing communication using a parameter set different from the parameter set used by the neighbor cell for communication with the serving cell, the terminal apparatus suppresses interference using a linear method without canceling neighbor cell interference by using assist information. For example, in a case that the neighbor cell supports multiple parameter sets, the terminal apparatus does not cancel neighbor cell interference by using assist information. For example, in a case that the neighbor cell supports a single parameter set and performs communication by using a parameter set different from the serving cell, the terminal apparatus does not cancel neighbor cell interference by using assist information.

Note that the communication system according to the present embodiment may include a System frame number (SFN) for frame synchronization between the base station apparatus and the terminal apparatus and between terminal apparatuses connected to the base station apparatus. The SFN may be a serial number of a frame transmitted from the base station apparatus or the terminal apparatus. The communication system according to the present embodiment may count SFNs by using a certain time length as a unit irrespective of a frame structure configured by the base station apparatus a radio parameter defining a frame structure, a base parameter determining a parameter for a radio frame, or a parameter set). In other words, the base station apparatus according to the present invention is capable of performing transmission in which terminal apparatuses having different frame structures configured by the base station apparatus receive frame having the same SFN and received subframe numbers (or the numbers of received subframes or the numbers of received OFDM symbols) are different.

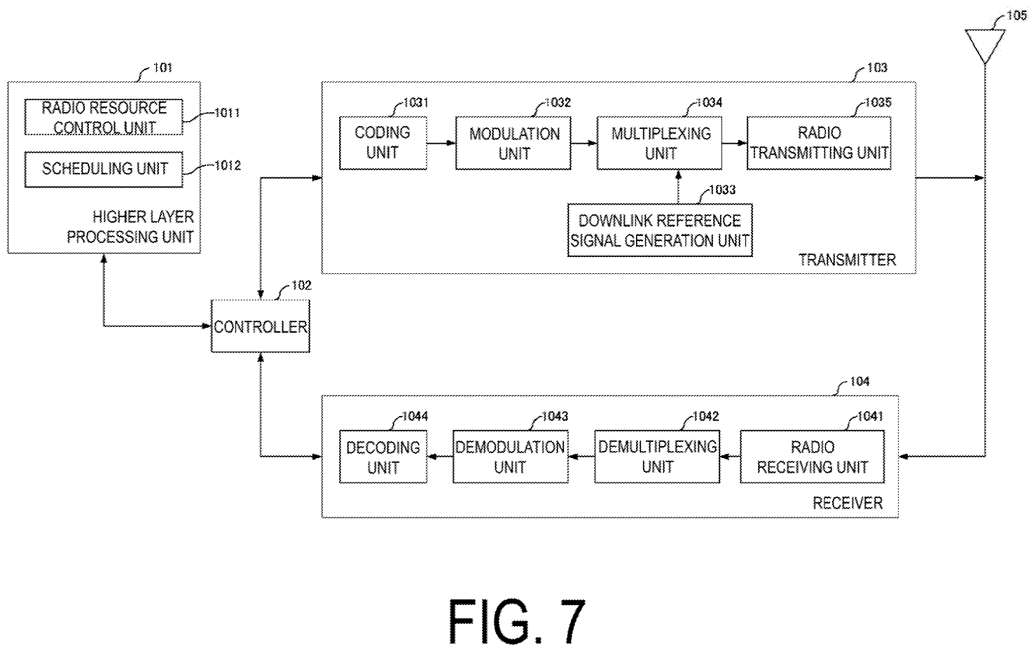

FIG. 7 is a schematic block diagram illustrating a configuration of the base station apparatus 1A according to the present embodiment. As illustrated in FIG. 7, the base station apparatus 1A is configured, including a higher layer processing unit (higher layer processing step) 101, a controller (controlling step) 102, a transmitter (transmitting step) 103, a receiver (receiving step) 104, and a transmit and receive antenna 105. The higher layer processing unit 101 is configured, including a radio resource control unit (radio resource controlling step) 1011 and a scheduling unit (scheduling step) 1012. The transmitter 103 is configured, including a coding unit (coding step) 1031, a modulation unit (modulating step) 1032, a downlink reference signal generation unit (downlink reference signal generating step) 1033, a multiplexing unit (multiplexing step) 1034, and a radio transmitting unit (radio transmitting step) 1035. The receiver 104 is configured, including a radio receiving unit (radio receiving step) 1041, a demultiplexing unit (demultiplexing step) 1042, a demodulation unit (demodulating step) 1043, and a decoding unit (decoding step) 1044.

The higher layer processing unit 101 performs processing of the Medium Access Control (MAC) layer, the Packet Data Convergence Protocol (PDCP) layer, the Radio Link Control (RLC) layer, and the Radio Resource Control (RRC) layer. Furthermore, the higher layer processing unit 101 generates information necessary for control of the transmitter 103 and the receiver 104, and outputs the generated information to the controller 102.

The higher layer processing unit 101 receives information of a terminal apparatus, such as LTE capability or the like, from the terminal apparatus. To rephrase, the terminal apparatus transmits its function to the base station apparatus by higher layer signaling.

Note that in the following description, information of a terminal apparatus includes information indicating whether the stated terminal apparatus supports a prescribed function, or information indicating that the stated terminal apparatus has completed the introduction and test of a prescribed function. In the following description, information of whether the prescribed function is supported includes information of whether the introduction and test of the prescribed function have been completed.

For example, in a case that a terminal apparatus supports a prescribed function, the stated terminal apparatus transmits information (parameters) indicating whether the prescribed function is supported. In a case that a terminal apparatus does not support a prescribed function, the stated terminal apparatus does not transmit information (parameters) indicating whether the prescribed function is supported. In other words, whether the prescribed function is supported is reported by whether information (parameters) indicating whether the prescribed function is supported is transmitted. Information (parameters) indicating whether a prescribed function is supported may be reported using one bit of 1 or 0.

The radio resource control unit 1011 generates, or acquires from a higher node, the downlink data (the transport block) mapped to the downlink PDSCH, system information, the RRC message, the MAC CE, and the like. The radio resource control unit 1011 outputs the downlink data to the transmitter 103, and outputs other information to the controller 102. Furthermore, the radio resource control unit 1011 manages various configuration information of the terminal apparatuses. The radio resource control unit 1011 configures (manages) downlink reference parameters (subcarrier spacings), CP lengths, the numbers of FFT points, and the like. The radio resource control unit 1011 configures (manages) terminal apparatus (uplink) reference parameters (subcarrier spacings), CP lengths, the numbers of FFT points, and the like.

The scheduling unit 1012 determines a frequency and a subframe to which the physical channels (PDSCH and PUSCH) are allocated, the coding rate and modulation scheme (or MCS) for the physical channels (PDSCH and PUSCH), the transmit power, and the like. The scheduling unit 1012 outputs the determined information to the controller 102.

The scheduling unit 1012 generates the information to be used for the scheduling of the physical channels (PDSCH and PUSCH), based on the result of the scheduling. The scheduling unit 1012 outputs the generated information to the controller 102.

Based on the information input from the higher layer processing unit 101, the controller 102 generates a control signal for controlling of the transmitter 103 and the receiver 104. The controller 102 generates the downlink control information based on the information input from the higher layer processing unit 101, and outputs the generated information to the transmitter 103.

The transmitter 103 generates the downlink reference signal in accordance with the control signal input from the controller 102, codes and modulates the HARQ indicator, the downlink control information, and the downlink data that are input from the higher layer processing unit 101, multiplexes PHICH, PDCCH, EPDCCH, PDSCH, and the downlink reference signal, and transmits a signal obtained through the multiplexing to the terminal apparatus 2 through the transmit and receive antenna 105.

The coding unit 1031 codes the HARQ indicator, the downlink control information, and the downlink data that are input from the higher layer processing unit 101, in compliance with the coding scheme prescribed in advance, such as block coding, convolutional coding, or turbo coding, or in compliance with the coding scheme determined by the radio resource control unit 1011. The modulation unit 1032 modulates the coded bits input from the coding unit 1031, in compliance with the modulation scheme prescribed in advance, such as Binary Phase Shift Keying (BPSK), quadrature Phase Shift Keying (QPSK), quadrature amplitude modulation (16QAM), 64QAM, or 256QAM, or in compliance with the modulation scheme determined by the radio resource control unit 1011.

The downlink reference signal generation unit 1033 generates, as the downlink reference signal, a sequence that is already known to the terminal apparatus 2A and that is acquired in accordance with a rule prescribed in advance based on the physical cell identity (PCI, cell ID) for identifying the base station apparatus 1A, and the like.

The multiplexing unit 1034 multiplexes the modulated modulation symbol of each channel, the generated downlink reference signal, and the downlink control information. To be more specific, the multiplexing unit 1034 maps the modulated modulation symbol of each channel, the generated downlink reference signal, and the downlink control information to the resource elements.

The radio transmitting unit 1035 performs Inverse Fast Fourier Transform (IFFT) on the modulation symbol resulting from the multiplexing or the like, generates an OFDM symbol, adds a cyclic prefix (CP) to the generated OFDM symbol, generates a baseband digital signal (OFDM signal), converts the baseband digital signal into an analog signal, removes unnecessary frequency components through filtering, up-converts a result of the removal into a signal of a carrier frequency, performs power amplification to generate a radio signal, and outputs the radio signal to the transmit and receive antenna 105 for transmission.

In accordance with the control signal input from the controller 102, the receiver 104 demultiplexes, demodulates, and decodes the reception signal received from the terminal apparatus 2A through the transmit and receive antenna 105, and outputs information resulting from the decoding to the higher layer processing unit 101.

The radio receiving unit 1041 converts, by down-converting, an uplink signal received through the transmit and receive antenna 105 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 1041 removes a portion corresponding to CP from the digital signal resulting from the conversion. The radio receiving unit 1041 performs Fast Fourier Transform (FFT) on the signal from which CP has been removed, extracts a signal in the frequency domain, and outputs the resulting signal to the demultiplexing unit 1042.

The demultiplexing unit 1042 demultiplexes the signal input from the radio receiving unit 1041 into PUCCH, PUSCH, and the signal such as the uplink reference signal. The demultiplexing is performed based on radio resource allocation information that is determined in advance by the base station apparatus 1A using the radio resource control unit 1011 and that is included in the uplink grant notified to each of the terminal apparatuses 2.

Furthermore, the demultiplexing unit 1042 makes a compensation of channels including PUCCH and PUSCH. The demultiplexing unit 1042 demultiplexes the uplink reference signal.

The demodulation unit 1043 performs Inverse Discrete Fourier Transform (IDFT) on PUSCH, acquires modulation symbols, and performs reception signal demodulation, that is, demodulates each of the modulation symbols of PUCCH and PUSCH, in compliance with the modulation scheme prescribed in advance, such as BPSK, QPSK, 16QAM, 64QAM, 256QAM, or the like, or in compliance with the modulation scheme that the base station apparatus 1A itself notified in advance, with the uplink grant, each of the terminal apparatuses 2.

The decoding unit 1044 decodes the coded bits of PUCCH and PUSCH, which have been demodulated, at the coding rate in compliance with a coding scheme prescribed in advance, the coding rate being prescribed in advance or being notified in advance with the uplink grant to the terminal apparatus 2 by the base station apparatus 1A itself, and outputs the decoded uplink data and uplink control information to the higher layer processing unit 101. In a case that PUSCH is re-transmitted, the decoding unit 1044 performs the decoding with the coded bits input from the higher layer processing unit 101 and retained in an HARQ buffer, and the demodulated coded bits.

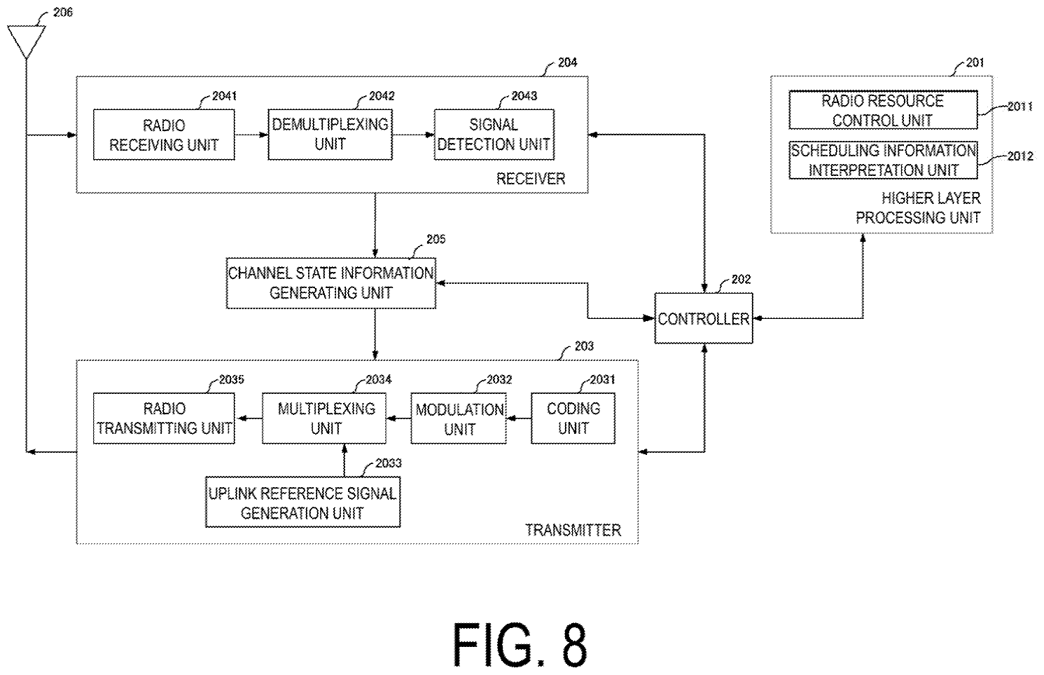

FIG. 8 is a schematic block diagram illustrating a configuration of the terminal apparatus 2 according to the present embodiment. As illustrated in FIG. 7, the terminal apparatus 2A is configured, including a higher layer processing unit (higher layer processing step) 201, a controller (controlling step) 202, a transmitter (transmitting step) 203, a receiver (receiving step) 204, a channel state information generating unit (channel state information generating step) 205, and a transmit and receive antenna 206. The higher layer processing unit 201 is configured, including a radio resource control unit (radio resource controlling stop) 2011 and a scheduling information interpretation unit (scheduling information interpreting step) 2012. The transmitter 203 is configured, including a coding unit (coding step) 2031, a modulation unit (modulating step) 2032, an uplink reference signal generation unit (uplink reference signal generating step) 2033, a multiplexing unit (multiplexing step) 2034, and a radio transmitting unit (radio transmitting step) 2035. The receiver 204 is configured, including a radio receiving unit (radio receiving step) 2041, a demultiplexing unit (demultiplexing step) 2042, and a signal detection unit (signal detecting step) 2043.

The higher layer processing unit 201 outputs the uplink data (the transport block) generated by a user operation or the like, to the transmitter 203. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs, to the transmitter 203, information indicating a terminal apparatus function supported by the terminal apparatus 2A itself.

Furthermore, the radio resource control unit 2011 manages various configuration information of the terminal apparatuses 2A itself. Furthermore, the radio resource control unit 2011 generates information to be mapped to each uplink channel, and outputs the generated information to the transmitter 203.

The radio resource control unit 2011 acquires configuration information of CSI feedback transmitted from the base station apparatus, and outputs the acquired information to the controller 202. The radio resource control unit 1011 acquires, from the base station apparatus, configuration information such as the downlink reference parameters (subcarrier spacings), the CP lengths, and the numbers of FFT points, and outputs the configuration information to the controller 202. The radio resource control unit 1011 acquires, from the base station apparatus, the configuration information such as the uplink reference parameters (subcarrier spacings), the CP lengths, and the numbers of FFT points, and outputs the configuration information to the controller 202.

The scheduling information interpretation unit 2012 interprets the downlink control information received through the receiver 204, and determines scheduling information. The scheduling information interpretation unit 2012 generates the control information in order to control the receiver 204 and the transmitter 203 in accordance with the scheduling information, and outputs the generated information to the controller 202.

Based on the information input from the higher layer processing unit 201, the controller 202 generates a control signal for controlling the receiver 204, the channel state information generating unit 205, and the transmitter 203. The controller 202 outputs the generated control signal to the receiver 204, the channel state information generating unit 205, and the transmitter 203 to control the receiver 204 and the transmitter 203.

The controller 202 controls the transmitter 203 to transmit CSI generated by the channel state information generating unit 205 to the base station apparatus.

In accordance with the control signal input from the controller 202, the receiver 204 demultiplexes, demodulates, and decodes a reception signal received from the base station apparatus 1A through the transmit and receive antenna 206, and outputs the resulting information to the higher layer processing unit 201.

The radio receiving unit 2041 converts, by down-converting, a downlink signal received through the transmit and receive antenna 206 into a baseband signal, removes unnecessary frequency components, controls an amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 2041 removes a portion corresponding to CP from the digital signal resulting from the conversion, performs fast Fourier transform on the signal from which CP has been removed, and extracts a signal in the frequency domain.

The demultiplexing unit 2042 demultiplexes the extracted signal into PHICH, PDCCH, EPDCCH, PDSCH, and the downlink reference signal. Further, the demultiplexing unit 2042 makes a compensation of channels including PHICH, PDCCH, and EPDCCH based on a channel estimation value of the desired signal obtained from the channel measurement, detects the downlink control information, and outputs the information to the controller 202. The controller 202 outputs PDSCH and the channel estimation value of the desired signal to the signal detection unit 2043.

The signal detection unit 2043, using PDSCH and the channel estimation value, detects a signal, and outputs the detected signal to the higher layer processing unit 201.

The transmitter 203 generates the uplink reference signal in accordance with the control signal input from the controller 202, codes and modulates the uplink data (the transport block) input from the higher layer processing unit 201, multiplexes PUCCH, PUSCH, and the generated uplink reference signal, and transmits a result of the multiplexing to the base station apparatus 1A through the transmit and receive antenna 206.

The coding unit 2031 codes the uplink control information input from the higher layer processing unit 201 in compliance with a coding scheme, such as convolutional coding or block coding. Furthermore, the coding unit 2031 performs turbo coding in accordance with information used for the scheduling of PUSCH.

The modulation unit 2032 modulates coded bits input from the coding unit 2031, in compliance with the modulation scheme notified with the downlink control information, such as BPSK, QPSK, 16QAM, or 64QAM, or in compliance with a modulation scheme prescribed in advance for each channel.

The uplink reference signal generation unit 2033 generates a sequence acquired according to a rule (formula) prescribed in advance, based on a physical cell identity (PCI, also referred to as a Cell ID or the like) for identifying the base station apparatus 1A, a bandwidth to which the uplink reference signal is mapped, a cyclic shift notified with the uplink grant, a parameter value for generation of a DMRS sequence, and the like.

In accordance with the control signal input from the controller 202, the multiplexing unit 2034 rearranges modulation symbols of PUSCH in parallel and then performs Discrete Fourier Transform (DFT) on the rearranged modulation symbols. Furthermore, the multiplexing unit 2034 multiplexes PUCCH and PUSCH signals and the generated uplink reference signal for each transmit antenna port. To be more specific, the multiplexing unit 2034 maps the PUCCH and PUSCH signals and the generated uplink reference signal to the resource elements for each transmit antenna port.

The radio transmitting unit 2035 performs Inverse Fast Fourier Transform (IFFT) on a signal resulting from the multiplexing, performs the modulation of SC-FDMA scheme, generates an SC-FDMA symbol, adds CP to the generated SC-FDMA symbol, generates a baseband digital signal (SC-FDMA signal), converts the baseband digital signal into an analog signal, removes unnecessary frequency components, up-converts a result of the removal into a signal of a carrier frequency, performs power amplifcation, and outputs a final result to the transmit and receive antenna 206 for transmission.

Note that the terminal apparatus 2 may perform OFDMA modulation without being limited to SC-TDMA modulation.

The controller 202 of the terminal apparatus 2 according to the present embodiment has a function of controlling transmit power of an uplink signal generated by the transmitter 203 to the base station apparatus 1. The controller 202 may, for example, calculate a transmit power P_{PUSCH, c}(i) relating to transmission of the i-th subframe to be transmitted to the c-th cell, according to Equation (1).

$$\begin{matrix}[ Equation 1 ] & \\ {P}_{PUSCH , c} ( i ) = min \{ \begin{matrix}{P}_{CMAX , c} ( i ) , \\ ( \begin{matrix}10 {log}_{10} ( {M}_{PUSCH , c} ( i ) ) + {P}_{O\_PUSCH , c} ( j ) + \\ {α}_{c} ( j ) \cdot {PL}_{c} + {Δ}_{TF , c} ( i ) + {f}_{c} ( i )\end{matrix} )\end{matrix} & ( 1 )\end{matrix}$$

P_{CMAX, c}(i) is a term relating to the maximum permissible transmit power of the terminal apparatus 2 relating to the transmission of the i-th subframe to be transmitted to the c-th cell. M_{PUSCH, c}(i) denotes the number of resource blocks allocated to the terminal apparatus 2 in the transmission of the i-th subframe to be transmitted to the c-th cell. In other words, the term denoted by 10 log₁₀(M_{PUSCH, c}(i)) is a term relating to the radio resource amount allocated to the terminal apparatus 2. P_{O_PUSCH, c}(j) is a term relating to a target receive power at the time of transmission to the c-th cell and is also referred to as a term relating to a target receive power at the time when the terminal apparatus 2 transmits an uplink signal to the base station apparatus 1 including the c-th cell. Note that j is an integer, and P_{O_PUSCH, c}(j) may be changed to a different value by changing j. α_{c}(j) is a term (coefficient) relating to propagation loss compensation between the base station apparatus 1 including the c-th cell and the terminal apparatus 2. Note that j is an integer, and α_{c}(j) may be changed to a different value by changing j. PL_{c} is a term relating to propagation loss between the base station apparatus 1 including the c-th cell and the terminal apparatus 2. Δ_{TF, c}(i) is a term relating to a modulation scheme used by the modulating unit 2032 for a signal included in the i-th subframe to be transmitted to the c-th cell, f_{c}(i) is a term relating to control error to occur at the time when the controller 202 controls a transmit power for a signal included in the i-th subframe to be transmitted to the c-th cell. Note that, the variable name of each term in Equation (1) is configured for the purpose of explanation, and hence an operation of the terminal apparatus 2 according to the present embodiment is not limited by the variable name, and the variable name may be any name.

The controller 202 of the terminal apparatus 2 according to the present embodiment may control a transmit power, based on the frame structure configured by the multiplexing unit 2034 (transmitter 203) (or a radio parameter defining a frame structure, a base parameter determining a parameter for the radio frame, a parameter set, a reference parameter, or a reference parameter set). Specifically, at least one term of the multiple terms included in Equation (1) is associated with the frame structure configured by the multiplexing unit 2034.

The controller 202 according to the present embodiment may control a transmit power by using one subframe length as a unit of control as can be seen in Equation (1). The controller 202 may also be able to control a transmit power by using any unit of control, such as a slot length, an OFDM symbol length, an SC-FDMA symbol length, a frame length, or the like, instead of a subframe length. The controller 202 according to the present embodiment may configure a unit for controlling a transmit power, based on the frame structure configured by the multiplexing unit 2034. For example, the time interval (temporal granularity) used by the controller 202 to control a transmit power for the 100-th frame structure with a wide subcarrier spacing may be smaller than the 200-th frame structure, which is a frame structure with a narrower subcarrier spacing than that of the 100-th frame structure. Through such control, the controller 202 may be able to control a transmit power for a signal including a frame structure of a shorter frame length (symbol length), more flexibly. The controller 202 according to the present embodiment may be able to change, for each frame structure, a time unit to be used for calculation of multiple terms included in the Equation (1).

The controller 202 according to the present embodiment may be able to configure, for each frame structure, a term relating to the maximum permissible transmit power in the Equation (1). For example, the controller 202 may be able to configure the maximum permissible transmit power for a frame structure required to have high reliability, to be higher than those for other frame structures. With such a configuration, an uplink signal transmitted to the base station apparatus 1 in a frame structure with a high maximum permissible transmit power may be received by the base station apparatus 1 with higher reception quality than that of a signal transmitted in another frame structure. Note that, in a case that high reliability is required (e.g., a case of a prescribed frame structure), the terminal apparatus 2 may always perform transmission with the maximum permissible transmit power without performing transmit power control, in response to an instruction or configuration from the base station apparatus 1.

The controller 202 according to the present embodiment may be able to configure, for each frame structure, a term relating to a radio resource amount allocated to the terminal apparatus 2 in Equation (1). The controller 202 according to the present embodiment may be able to configure a term relating to the radio resource amount by using a common unit, irrespective of frame structure. For example, the controller 202 according to the present embodiment may be able to configure a term relating to a radio resource amount by using, as a unit, RB-2 in which the frequency bandwidth per unit time is fixed. The bandwidth per unit of RB-2 is fixed uniquely, and hence parameters included in a frame structure and having different subcarrier spacings come to have different numbers of subcarriers included in RB-2. By using a common frequency unit, the controller 202 may be able to configure a term relating to the radio resource amount, irrespective of frame structure.

The controller 202 according to the present embodiment may configure, for each frame structure, a term relating to a target receive power in Equation (1). For example, the controller 202 may configure the target receive power configured in a case of a prescribed frame structure, to be higher or to be lower than the target receive power configured in a case of a frame structure other than the prescribed frame structure. By the controller 202 configuring the target receive power configured for the prescribed frame structure, to be high, the reception quality of a signal having the prescribed frame structure may be improved. In contrast, by the controller 202 configuring the target receive power configured for the prescribed frame structure, to be low, interference power for the other cells and neighbor channels due to a signal having the prescribed frame structure may be reduced.

The controller 202 according to the present embodiment may further add, to the term relating to the target receive power in Equation (1), a term relating to gain obtained through beamforming performed by the base station apparatus 1 and the terminal apparatus 2. For example, the controller 202 may define B_{c}(i) as a compensation coefficient relating to beamforming gain and configure B_{c}(i)*P_{O_PUSCH, c}(j) as the term relating to the target receive power. In a case that the prescribed frame structure is configured, the controller 202 may consider the compensation coefficient relating to the beamforming gain. The controller 202 may determine the compensation coefficient relating to the beamforming gain depending on whether or not the transmit and receive antenna 206 of the terminal apparatus 2 or the transmit and receive antenna 105 of the base station apparatus 1 performs beamforming. For example, the controller 202 may configure B_{c}(i) at 1 in a case that no beamforming is performed and configure B_{c}(i) at a real number equal to or smaller than 1 and greater than 0 in a case that beamforming is performed.

The controller 202 may configure, for each frame structure, a term relating to propagation loss compensation in Equation (1). The controller 202 may configure, for each frame structure, a value included in a set of values that may be configured in the term relating to propagation loss compensation.

The controller 202 may configure, for each frame structure, a term relating to propagation loss in Equation (1). For example, in a case that the prescribed frame structure is configured, the controller 202 may consider the compensation coefficient relating to the beamforming gain for the term relating to propagation loss. For example, in a case that the prescribed frame structure is configured, the controller 202 may measure the propagation loss in consideration of the gain through beamforming performed by the base station apparatus 1 and the terminal apparatus 2, at the time of configuring the propagation loss.

The controller 202 may further add a term relating to beamforming to Equation (1). As the term relating to beamforming, the controller 202 may configure gain obtained through beamforming performed by the base station apparatus 1 and the terminal apparatus 2. In a case that the prescribed frame structure is configured, the controller 202 may configure a value selected from multiple values, to the term relating to beamforming. In a case that a frame structure other than the prescribed frame structure is configured, the controller 202 may configure a prescribed value (e.g., 0) to the term relating to beamforming. The controller 202 may configure the difference between the gain obtained through beamforming performed by the base station apparatus 1 and the terminal apparatus 2 and gain obtained through reference beamforming. As the gain obtained through the reference beamforming, the controller 202 may use, for example, information relating to reception gain of a common reference signal transmitted from the base station apparatus 1 or a signal including common control information. The controller 202 may use information relating to reception gain of a specific reference signal or a signal including data destined to the terminal apparatus 2 and information relating to gain obtained through beamforming.

In a case of controlling a transmit power of an uplink signal having a prescribed frame structure, based on Equation (1), the controller 202 may calculate multiple terms included in Equation (1) by using a value configured for the prescribed frame structure. The controller 202 may alternatively configure one or multiple of the multiple terms in Equation (1) at a common value, irrespective of a difference in configured frame structure. For example, regarding propagation loss, propagation loss calculated for a certain frame structure may be used as propagation loss in another frame structure.

In a case of controlling a transmit power of an uplink signal having a prescribed frame structure, based on Equation (1) and further the terminal apparatus 2 transmitting an uplink signal by using multiple component carriers simultaneously (by carrier aggregation), the controller 202 may calculate transmit power for each component carrier and control a transmit power, based on the total value of the transmit power. In this operation, for the addition of transmit powers of respective component carriers, the controller 202 may perform addition with weighting for each component carrier, instead of performing simple addition. The controller 202 may determine a weighting coefficient to be performed for each component carrier, based on the frame structure configured for the component carrier. It goes without saying that the controller 202 according to the present embodiment may also perform control of transmit powers at the time of perform carrier aggregation on multiple component carriers for which different frame structures are configured.

In a case that the controller 202 controls a transmit power of an uplink signal having a prescribed frame structure, based on Equation (1) and the terminal apparatus 2 further transmits at least part of a data signal and a control signal as uplink signals in different frequency resources simultaneously, the controller 202 may subtract a transmit power required for transmission of the control signal from the term relating to the maximum permissible transmit power in Equation (1). Such control enables the terminal apparatus 2 to avoid a problem of not being able to transmit a control signal. The transmit power required for transmission of the control signal subtracted by the controller 202 according to the present embodiment from the term relating to the maximum permissible transmit power in Equation (1) may be configured based on the frame structure configured for the signal including the control signal.

The receiver 204 (higher layer processing unit 201) of the terminal apparatus 2 may acquire, from the base station apparatus 1, control information relating to at least one of the multiple terms included in Equation (1). The terminal apparatus 2 may acquire the control information from broadcast information (e.g., information included in Master Information Block (MIB) or System Information Block (SIB) broadcast via a Broadcast Channel (BCH)) of the base station apparatus 1. The terminal apparatus 2 may acquire the control information from control information of the physical layer transmitted by the base station apparatus 1 (e.g., DCI reported via the PDCCH). The cycle in which the terminal apparatus 2 acquires the control information from the base station apparatus 1 may be different for each configured frame structure.

The control information relating to at least one of the multiple terms included in Equation (1) and acquired by the terminal apparatus 2 may be associated with a prescribed frame structure among multiple frame structures. The controller 202 may configure at least one of the multiple terms included in Equation (1) and associated with a frame structure other than the prescribed frame structure, based on the control information associated with the acquired prescribed frame structure.

The base station apparatus 1 may report, to the terminal apparatus 2, the control information relating to at least one of the multiple terms included in Equation (1) to he used by the terminal apparatus 2 to control a transmit power. The control information that the base station apparatus 1 reports, to the terminal apparatus 2, and a method of the report may be determined based on a frame structure configured by the base station apparatus 1. The base station apparatus 1 may broadcast the control information associated with the prescribed frame structure by including the control information in broadcast information (e.g., information included in Master Information Block (MIB) or System Information Block (SIB) broadcast via a Broadcast Channel (BCH)). The base station apparatus 1 may transmit the control information associated with a prescribed frame structure by including the control information in physical layer control information (e.g., a signal including DCI and a TPC command to be reported via the PDCCH). The cycle in which the base station apparatus 1 broadcasts or transmits a signal including the control information may be different for each configured frame structure. Note that the base station apparatus 1 may be configured so that the pieces of control information associated with different frame structures would not be transmitted simultaneously. The base station apparatus 1 may be configured so that the control information associated with a prescribed frame structure would be reported to the terminal apparatus 2 only through a signal having the prescribed frame structure.

The controller 202 according to the present embodiment may configure a transmit power per subcarrier to be a different value for each frame structure in control of transmit powers. For example, the transmit power per subcarrier for a frame structure having a subcarrier spacing of 15 kHz may be configured to be half the transmit power per subcarrier for a frame structure having a subcarrier spacing of 30 kHz. By the controller 202 thus controlling a transmit power, the transmit power per unit of frequency for an uplink signal transmitted from the terminal apparatus 2 (e.g., the transmit power per 1 MHz or transmit power spectral density) to be fixed, irrespective of frame structure. Such control improves flatness (degree of flatness, smoothness) of a signal spectrum of a signal transmitted from the terminal apparatus 2, for example.

The terminal apparatus 2 according to the present embodiment may report information relating to a capability of configuring a transmit power of the terminal apparatus itself to the base station apparatus 1. The information relating to the configuration capability may be Power headroom (PH). The controller 202 of the terminal apparatus 2 according to the present embodiment may calculate power headroom PH_{type1, c}(i) relating to transmission of the i-th subframe to be transmitted to the c-th cell, based on Equation (2), for example.

[Equation 2]

P_{PUSCH,c}(i)=P_{CMAX,c}(i)−{10 log₁₀(M_{PUSCH,c}(i))+P_{O_PUSCH,c}(j)+α_{c}(j)·PL_{c}+Δ_{TF,c}(i)+f_{c}(i)} (2)

As presented in Equation (2), the PH is represented by the difference between the maximum permissible transmit power of the terminal apparatus 2 and the transmit power requested to the terminal apparatus 2 by the base station apparatus 1. In a case that the PH is a positive value, this represents that the terminal apparatus 2 still has a remaining transmit power (the terminal apparatus 2 is able to transmit a signal at a higher transmit power than the current transmit power). In a case that the PH is 0, this represents that the terminal apparatus 2 has less remaining transmit power (the terminal apparatus 2 is not able to transmit a signal at a transmit power higher than current transmit power). In a case that the PH is a negative value, this represents that the terminal apparatus 2 is not able to transmit a signal at the transmit power requested by the base station apparatus 1. By the terminal apparatus 2 reporting the PH to the base station apparatus 1, the base station apparatus 1 may acquire a radio resource amount to be allocated to the terminal apparatus 2. Note that, in a case that the terminal apparatus 2 is not allocated any resource and the PH is reported to the base station apparatus 1, the terminal apparatus 2 may calculate the PH without taking any radio resource amount into consideration. In a case that resources are allocated but transmission has failed for some reason, the terminal apparatus 2 may calculate the PH by taking the allocated resources into consideration.

The terminal apparatus 2 according to the present embodiment may report the PH to the base station apparatus 1 for each frame structure. The cycle in which the terminal apparatus 2 reports the PH to the base station apparatus 1 may be different for each frame structure. The terminal apparatus 2 may notify the base station apparatus 1 of only the PH relating to the frame structure requested by the base station apparatus 1.

The base station apparatus 1 and the terminal apparatus 2 may agree on a prescribed frame structure to calculate the PH, in advance. In this case, based on the PH associated with a prescribed frame structure reported by the terminal apparatus 2, the base station apparatus 1 may calculate the PH associated with a frame structure other than the prescribed frame structure.

Note that, in Equation (2), the terms subtracted from the maximum permissible transmit power include all the multiple terms included in Equation (1) used by the controller 202 to calculate the transmit power. The controller 202 according to the present embodiment may not necessarily include all the multiple terms included in Equation (1) in the terms subtracted from the maximum permissible transmit power at the time of calculating the PH. A combination of terms that the controller 202 includes in the terms subtracted from the maximum permissible transmit power may be different for each configured frame structure or may be in common among frame structures.

Note that the terminal apparatus 2 according to the present embodiment may always transmit an uplink signal at the maximum permissible transmit power of the terminal apparatus itself in a prescribed frame structure. In this case, the PH is always 0 as long as the prescribed frame structure is configured, and hence the terminal apparatus 2 may not necessarily report the PH to the base station apparatus 1. In other words, by configuring a prescribed frame structure, the terminal apparatus 2 of the present embodiment is able to be configured not to transmit the PH.

A program running on an apparatus according to an aspect of the present invention may be a program that controls a Central Processing Unit (CPU) and the like to cause a computer to operate in such a manner as to realize the functions of the embodiment according to an aspect of the present invention. Programs or the information handled by the programs are temporarily stored in a volatile memory, such as a Random Access Memory (RAM), a non-volatile memory, such as a flash memory, a Hard Disk Drive (HDD), or another storage device system.

Note that a program for realizing functions of the embodiment according to the present invention may be recorded on a computer-readable recording medium. The program recorded on the recording medium may be read into a computer system for execution to realize the functions. It is assumed that the “computer system” here refers to a computer system built into the apparatuses, and the computer system includes an operating system and hardware components such as a peripheral device. Furthermore, the “computer-readable recording medium” may be a semiconductor recording medium, an optical recording medium, a magnetic recording medium, a medium that dynamically holds a program for a short time, or another computer-readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or another programmable logic device, a discrete gate or a transistor logic, a discrete hardware component, or a combination thereof. Although the general-purpose processor may be a microprocessor or a processor of known type, a controller, a micro-controller, or a state machine. The above-described electric circuit may be constituted of a digital circuit or may be constituted of an analog circuit. Furthermore, in a case that with advances in semiconductor technology, a circuit integration technology appears that replaces the present integrated circuits, one or multiple aspects of the present invention may use a new integrated circuit based on the technology.

Note that the invention of the present patent application is not limited to the above-described embodiments. In the embodiments, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatus.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible to be made to an aspect of the present invention within the scope of the invention defined by claims, and embodiments that are made by suitably combining technical means disclosed according to the different embodiments are also included in the technical scope of the aspect of the present invention. Furthermore, a configuration in which constituent elements, described in the respective embodiments and having mutually the same effects, are substituted for one another is also included in the technical scope of the present invention.

### INDUSTRIAL APPLICABILITY

The present invention can be preferably used in a base station apparatus, a terminal apparatus, and a communication method.

The present international application claims priority based on JP 2016-191051 filed on Sep. 29, 2016, and all the contents of JP 2016-191051 are incorporated in the present international application by reference.

### REFERENCE SIGNS LIST

1A Base station apparatus
2A, 2B Terminal apparatus
101 Higher layer processing unit
102 Controller
103 Transmitter
104 Receiver
105 Transmit and receive antenna
1011 Radio resource control unit
1012 Scheduling unit
1031 Coding unit
1032 Modulation unit
1033 Downlink reference signal generation unit
1034 Multiplexing unit
1035 Radio transmitting unit
1041 Radio receiving unit
1042 Demultiplexing unit
1043 Demodulation unit
1044 Decoding unit
201 Higher layer processing unit
202 Controller
203 Transmitter
204 Receiver
205 Channel state information generating unit
206 Transmit and receive antenna
2011 Radio resource control unit
2012 Scheduling information interpretation unit
2031 Coding unit
2032 Modulation unit
2033 Uplink reference signal generation unit
2034 Multiplexing unit
2035 Radio transmitting unit
2041 Radio receiving unit
2042 Demultiplexing unit
2043 Signal detection unit

1-8. (canceled)

9. A base station apparatus configured to communicate with a terminal apparatus, the base station apparatus comprising:
higher layer processing circuitry configured to configure a subcarrier spacing for the terminal apparatus;
multiplexing circuitry configured to map a downlink shared channel to a resource element; and
radio transmitting circuitry configured to generate an orthogonal frequency division multiplexing (OFDM) signal using a cyclic prefix (CP) and a signal output from the multiplexing circuitry, convert the OFDM signal into a radio signal, and transmit the radio signal, wherein
the subcarrier spacing includes a first subcarrier spacing, a second subcarrier spacing, or a third subcarrier spacing,
the CP includes a first CP, a second CP, or a third CP,
in a same subcarrier spacing, the second CP is longer in length than the first CP,
in a same subcarrier spacing, the third CP is shorter in length than the first CP,
the first CP is used in the first subcarrier spacing,
the first CP and the second CP are used in the second subcarrier spacing,
at least the third CP is used in the third subcarrier spacing, and
the third subcarrier spacing is equal to or larger than a predetermined number.

10. The base station apparatus according to claim 9, wherein a length of the third CP is zero.

11. The base station apparatus according to claim 9, wherein
a length of the first CP and a length of the second CP are fixed in one subcarrier spacing, and
a length of the third CP is variable for each terminal apparatus.

12. A terminal apparatus configured to communicate with a base station apparatus, the terminal apparatus comprising:
higher layer processing circuitry configured to be configured with a subcarrier spacing;
radio receiving circuitry configured to extract a frequency domain signal from a reception signal in consideration of a cyclic prefix (CP);
demultiplexing circuitry configured to demultiplex a downlink shared channel from the frequency domain signal extracted; and
signal detection circuitry configured to detect the downlink shared channel, wherein
the subcarrier spacing includes a first subcarrier spacing, a second subcarrier spacing, or a third subcarrier spacing,
the CP includes a first CP, a second CP, or a third CP,
in a same subcarrier spacing, the second CP is longer in length than the first CP,
in a same subcarrier spacing, the third CP is shorter in length than the first CP,
the first CP is used in the first subcarrier spacing,
the first CP and the second CP are used in the second subcarrier spacing,
at least the third CP is used in the third subcarrier spacing, and
the third subcarrier spacing is equal to or larger than a predetermined number.

13. The terminal apparatus according to claim 12, wherein a length of the third CP is zero.

14. The terminal apparatus according to claim 12, wherein
a length of the first CP and a length of the second CP are fixed in one subcarrier spacing, and
a length of the third CP is variable for each terminal apparatus.

15. A communication method for a base station apparatus to communicate with a terminal apparatus, the communication method comprising:
configuring a subcarrier spacing for the terminal apparatus;
mapping a downlink shared channel to a resource element; and
generating an orthogonal frequency division multiplexing (OFDM) signal using a cyclic prefix (CP) and a signal output from the multiplexing circuitry, converting the OFDM signal into a radio signal, and transmitting the radio signal, wherein
the subcarrier spacing includes a first subcarrier spacing, a second subcarrier spacing, or a third subcarrier spacing,
the CP includes a first CP, a second CP, or a third CP,
in a same subcarrier spacing, the second CP is longer in length than the first CP,
in a same subcarrier spacing, the third CP is shorter in length than the first CP,
the first CP is used in the first subcarrier spacing,
the first CP and the second CP are used in the second subcarrier spacing,
at least the third CP is used in the third subcarrier spacing, and
the third subcarrier spacing is equal to or larger than a predetermined number.

16. A communication method for a terminal apparatus to communicate with a base station apparatus, the communication method comprising:
being configured with a subcarrier spacing;
extracting a frequency domain signal from a reception signal in consideration of a cyclic prefix (CP);
demultiplexing a downlink shared channel from the frequency domain signal extracted; and
detecting the downlink shared channel, wherein
the subcarrier spacing includes a first subcarrier spacing, a second subcarrier spacing, or a third subcarrier spacing,
the CP includes a first CP, a second CP, or a third CP,
in a same subcarrier spacing, the second CP is longer in length than the first CP,
in a same subcarrier spacing, the third CP is shorter in length than the first CP,
the first CP is used in the first subcarrier spacing,
the first CP and the second CP are used in the second subcarrier spacing,
at least the third CP is used in the third subcarrier spacing, and
the third subcarrier spacing is equal to or larger than a predetermined number.
